(19) United States
(12) Patent Application Publication
(10) Pub. No.: US 2001/0032864 A1
(43) Pub. Date: Oct. 25, 2001

(54) Fluid container for pump or spray device

(76) Inventor: Sean T. Shepherd, Scottsdale, AZ (US)

Correspondence Address: Gregory J. Nelson, NELSON & ROEDIGER, Suite 212, 3333 E. Camelback Road, Phoenix, AZ, 85018, US

(21) Appl. No.: 09/766,072

(22) Filed: Jan. 19, 2001

Related U.S. Application Data
(60) Provisional application No. 60/177,528, filed on Jan. 21, 2000.

(51) Int. Cl. B67D 5/60

(52) U.S. Cl. 222/321.5; 222/321.9; 222/464.7

(57) ABSTRACT

A pump or spray container for fluids such as lotions and shampoos. The container has a well in the bottom which collects the fluid contents when the level is low so that substantially all the contents can be dispensed by the pump or spray mechanism.

### A FLUID CONTAINER FOR PUMP OR SPRAY DEVICE

This application is based on provisional patent application serial number 60/177,528, filed Jan. 21, 2000, entitled “A Fluid Container For Pump or Spray Device.”

### FIELD OF THE INVENTION

The present invention relates to a container and more particularly relates to a container for a manually operable pump or spray device.

### BACKGROUND OF THE INVENTION

Many fluid products are provided to the consumer in a container from which the contents are dispensed by the use of manually operated pump or spray. Typical products of this type are personal care products such as soaps, lotions, shampoos, creams and similar products. Many house and garden products are provided in similar containers such as household cleansers, detergents, insect sprays and herbicides. Generally the containers for these type of products are made of plastic by blow-molding or injection molding. The shape of the containers may vary, some are cylindrical and some are ergonomically shaped to provide a grip for the hand of the user when operating the spray or pump. The spray or pump mechanism generally consists of a cap which is threaded engagement with threads on the top of the bottle. A suction tube extends through the cap to the bottom of the bottle. A pump or spray mechanism is attached to the suction tube and the contents are dispensed by either depressing a pump mechanism or squeezing a spray handle mechanisms. The contents are discharged through a nozzle or outlet in a stream, drop or mist, depending upon the type of dispensing actuator.

The problem with devices of these type is that the bottom of the bottle in most cases planar or may be slightly convex. Accordingly, since the pump extends into the container to a location just above the central portion of the floor, a portion of the contents cannot be evacuated when the liquid level falls below the lower tip or distal end of the suction tube. The contents usually settle toward the wall of the chamber away from the suction tube due to the configuration of the floor or bottom of the container. Thus, a small, but significant amount of the contents is often wasted and is discarded with the container.

Accordingly, there is a need for an improved fluid container configuration which will allow the user to expel substantially all of the contents of the container.

### SUMMARY OF THE INVENTION

Briefly, the present invention provides a container having a body of any convenient shape. The upper end of the container has a neck with a connector for attachment of a suitable dispensing mechanism such as a spray or pump mechanism. The spray or pump mechanism has a suction tube which extends within the container terminating at a location within a depression in the bottom of the container which forms a well. The depression may be circular or other shape and is slightly larger than the diameter of the suction tube. The floor or bottom of the container extends angularly upward from the edges of the well or the depression so that as the fluid level lowers within the container, the remaining fluid will flow along the wall of the floor into the center depression where is can be expelled by the suction tube so that substantially all of the contents of the container can be dispensed.

The above and other objects of the invention will become more apparent from the following description and drawings in which:

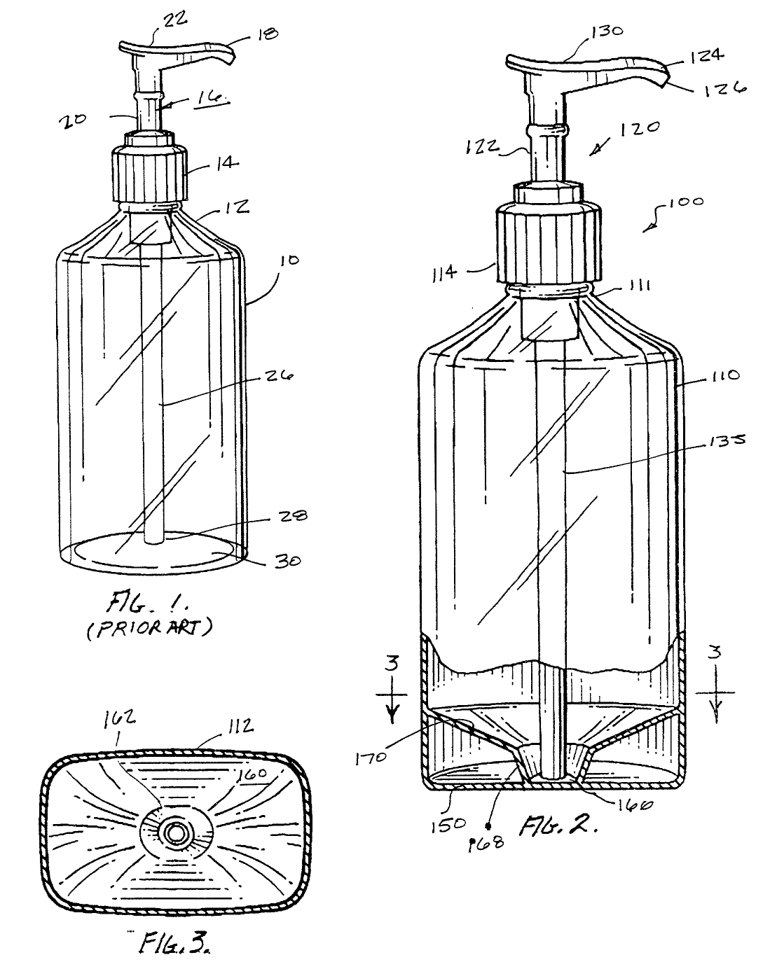

FIG. 1 is a perspective view showing the conventional prior art container;

FIG. 2 is a perspective view of a container according to the present invention with a portion of the container broken away to better illustrate the features of the invention;

FIG. 3 is a sectional view taken along line 3-3 of FIG. 2.

Turning now to the drawings, FIG. 1 is representative of prior art containers of a type used for personal, household and garden products. The container has a body portion 10 which may be any shape and is shown as being generally cylindrical. The upper end of the bottle forms a neck 12 which is threaded to receive a screw-on cap 14. The screw-on cap has a dispensing mechanism 16 which is shown as a pump having a dispensing nozzle 18. The pump is operable by means of a plunger 20 which is manually depressed by the user pushing or applying a downward force along surface 22 of the dispensing nozzle. A suction tube 26 depends into the bottle terminating at lower end 28. Lower end 28 is spaced slightly above the bottom wall or floor 30 of the container. The bottom wall 30 is generally either planar or may be slightly convected. Accordingly, a small volume of the contents of the container may not be dispensed or expelled by the pump mechanism once the fluid level drops below the end of tube 28. With prior art designs such as shown, some of the residual contents will flow from the center of the floor and from a residual which cannot be accessed by the pump mechanism. Accordingly, a small but significant quantity of the contents are generally wasted as containers of these types are typically single-use containers which are discarded after use.

Turning now to FIGS. 2 and 3, the container or the present invention that is shown is generally represented by the numeral 100. The container includes a bottle or housing 110 which may be any shape but is shown as having generally rectangular sidewall 112 which tapers inwardly at the top to a neck 111. Neck 111 is provided with a connector preferably threads which receive a screw-cap 114. The screw-cap 114 receives a dispensing device 120 which is shown as having a plunger section 122 which at its upper end receives a dispensing nozzle 124. The nozzle 124 terminates at discharge 126 which dispenses the contents of the container.

The upper surface 130 of the nozzle is shown as being slightly curved so a thumb or finger of the user can be applied to the surface so that a downward manual force can be applied causing the plunger 122 to be depressed. As the plunger 122 is depressed, contents of the container are drawn through the suction tube 13 5 by the action of the plunger and dispensed at discharge 126. The bottle and the plunger mechanism are somewhat conventional.

The bottle may be any shape. For example, neck 112 may be offset and may be formed having a grip portion so that the hand of the user may be placed about the bottle to assist in the dispensing operation. The dispensing mechanism 120 may be a pump as shown or may be a spray-type dispenser for applying the contents as a fine mist such as common with some household and garden products such as window cleaners, insecticides and herbicides. The bottle may be formed from any suitable materials such as a plastic by injection or blow-molding.

The improvement resides in the bottom or floor of the container which allows substantially all of the contents to be dispensed or evacuated by the dispensing mechanism 120. Accordingly, the bottle has an exterior bottom false 150 that is shown is generally planar so that the bottle may be placed on a surface without tipping or tilting. An inner bottom 160 is provided which has a well or depression 162 at a location positioned and received at the lower end of the section tube 135. In the case of the container shown in FIG. 2, the depression is centrally located. However, if the bottle is of a shape which the suction tube 135 is offset, a well or depression 162 would be similarly offset to receive the bottom end of the suction tube 135. The well or depression may be circular or oval having a diameter slightly larger than the diameter of the suction tube. Typically the suction tube for most house and garden containers is less than ½″ in diameter and accordingly, the depression would be slightly larger than this dimension. The depression has a bottom 166 and sidewall 168 which extend upwardly at a steep angle a small distance such as approximately ½inch. The upper end of the sidewall of the depression are annular formed as part of the bottom wall 170 which is as shown generally annular extending to the interior of the sidewall of the container. The floor extends downwardly at a angle which may be varied from a slight angle to an angle of 20° or 30°.

As seen in FIG. 2, as the contents of the container drop to a level below point A, which is the highest point of the floor of the container, the contents will be caused to flow downwardly into the depression or well within which the distal end of the suction tube is received. Accordingly, this will allow the contents of the container to be fully emptied with no substantial residual remaining resulting in economy and less wastage. As mentioned above, containers of this type are generally single-use containers so that the present invention enables the user or consumer to utilize substantially all of the contents of the container.

The container may be made from various materials such as plastic or glass and may be fabricated by conventional techniques. Similarly, the dispensing mechanism may be a plunger, spray mechanism or other type of dispenser having a suction or dispensing tube.

It will be apparent to those skilled in the art to make various changes, alterations and modifications to the dispensing device disclosed herein. To the extent that these various changes, alterations and modifications do not depart from the spirit and the scope of the invention as disclosed, they are intended to be encompassed therein.

I claim:

1. A fluid dispenser comprising of:
(a) a container having a side wall, top and bottom defining a fluid chamber;
(b) said bottom wall defining a depression and having a wall extending angularly upward from said depression to the side wall so that as the container is emptied, fluid will flow into said depression;
(c) a dispensing mechanism attachable to the top of said container having a dispensing tube depending into said container terminating at a distal end in said dispenser;

2. The fluid dispenser of claim 1 wherein said dispensing mechanism is a pump.

3. The fluid dispenser of claim 1 wherein said dispensing mechanism is a spray.

4. The fluid dispenser of claim 1 wherein said container is provided with a generally planar false bottom disposed below said bottom wall.

5. The fluid dispenser of claim 1 wherein said container is selected from the group of materials consisting of plastic, glass or metal.

6. The fluid dispenser of claim 1 wherein said bottom wall extends generally upwardly from said central well.
